(19) United States
(12) Patent Application Publication
(10) Pub. No.: US 2026/0083620 A1
(43) Pub. Date: Mar. 26, 2026

(54) PNEUMATIC COMPRESSION DEVICE

(71) Applicant: Therabody, Inc., Los Angeles, CA (US)

(72) Inventors: Jaime SANCHEZ SOLANA, Los Angeles, CA (US); Benjamin NAZARIAN, Beverly Hills, CA (US); Washington Alexander SILVA GARCES, Los Angeles, CA (US)

(21) Appl. No.: 18/891,990

(22) Filed: Sep. 20, 2024

(51) Int. Cl. A61H 9/00

(52) U.S. Cl. CPC A61H 9/0078; A61H 2205/10

(57) ABSTRACT

A compression therapy device includes a first sleeve configured to receive a first limb of a wearer. The compression therapy device also includes a second sleeve configured to receive a second limb of the wearer. The compression therapy devices also includes an air conduit network that extends from the first sleeve to the second sleeve. The compression therapy device also comprises a pump configured to inflate the first sleeve and the second sleeve through the air conduit network.

### BACKGROUND

Compression therapy devices are frequently used in pairs to apply simultaneous therapy to symmetrical features of a user. For example, a user may use two compression therapy boots at the same time to apply therapy to both legs. Using two compression therapy devices at the same time in this manner entails using two of each component of each compression therapy device, i.e., two controllers, two pumps, two user interfaces, sometimes with the objective of applying the same therapeutic protocol to both treated areas. Thus, using two compression therapy devices in this manner can be relatively expensive and require significant storage space.

### SUMMARY

Accordingly, there may be a need for providing new methods and devices for providing simultaneous compression therapy to symmetrical features of a user without using two of each component that may appear in a unilateral compression therapy device. Aspects of the present disclosure relate to a compression therapy device configured to treat two limbs of a user with two inflatable sleeves inflated by a single pump controlled by a single controller. Usage of only a single controller and a single pump to treat two limbs simultaneously in this manner can save cost and space in addition to providing simple means for ensuring that treatment of both limbs is synchronized. These benefits can be achieved with little to no loss of utility for users interested in applying the same therapeutic protocols to both limbs.

Some aspects of the present disclosure relate to a compression therapy device. The compression therapy device may comprise a first sleeve configured to receive a first limb of a wearer. The compression therapy device may also comprise a second sleeve configured to receive a second limb of the wearer. The compression therapy device may also comprise an air conduit network that extends from the first sleeve to the second sleeve. The compression therapy device may also comprise a pump configured to inflate the first sleeve and the second sleeve through the air conduit network.

In some embodiments according to the foregoing, the pump may be mounted to the first sleeve.

In some embodiments according to any of the foregoing, the compression therapy device may comprise a control panel mounted to the first sleeve.

In some embodiments according to any of the foregoing, the compression therapy device may comprise a bridge joining the first sleeve to the second sleeve. The bridge may comprise a passage. The air conduit network may extend through the passage into the second sleeve.

In some embodiments according to any of the foregoing, the compression therapy device may comprise a pump interface connecting the pump to the air conduit network. The air conduit network may comprise a first set of air conduits and a second set of air conduits. The first set of air conduits may comprise a first air conduit extending from the pump interface to an inflatable chamber of the first sleeve. The second set of air conduits may comprise a first air conduit extending from the pump interface to an inflatable chamber of the second sleeve. The pump interface may comprise a valve configured to control fluid communication between the pump and the both of the first air conduits simultaneously.

In some embodiments according to any of the foregoing, the valve may be a first valve. The first set of air conduits may comprise a second air conduit, a third air conduit, and a fourth air conduit. The second set of air conduits may comprise a second air conduit, a third air conduit, and a fourth air conduit. The pump interface may comprise a second valve configured to control fluid communication between the pump and both of the second air conduits simultaneously. The pump interface may comprise a third valve configured to control fluid communication between the pump and both of the third air conduits simultaneously. The pump interface may comprise a fourth valve configured to control fluid communication between the pump and both of the fourth air conduits simultaneously. The compression therapy device may comprise a controller configured to operate the first, second, third, and fourth valves independently.

In some embodiments according to any of the foregoing, the second air conduit, the third air conduit, and the fourth air conduit of the first set of air conduits may each extend to a respective inflatable chamber of the first sleeve. The second air conduit, the third air conduit, and the fourth air conduit of the second set of air conduits may each extend to a respective inflatable chamber of the second sleeve.

In some embodiments according to any of the foregoing, an end of the first air conduit of the first set of air conduits may be in fluid communication with an end of the first air conduit of the second set of air conduits through the pump interface.

In some embodiments according to any of the foregoing, the first sleeve and the second sleeve may each comprise a first inflatable chamber and a second inflatable chamber. The compression therapy device may be configured to change a pressure within the first inflatable chambers independently of a pressure within the second inflatable chambers.

In some embodiments according to any of the foregoing, the compression therapy device may comprise a pump interface connecting the pump to the air conduit network. The pump interface may comprise a first valve and a second valve. The first valve may be configured to control fluid communication between the pump and both first inflatable chambers simultaneously. The second valve may be configured to control fluid communication between the pump and both second inflatable chambers simultaneously.

In some embodiments according to any of the foregoing, the first limb may be a first leg and the second limb may be a second leg.

In some embodiments according to any of the foregoing, the first sleeve may comprise a first plurality of inflatable chambers and a first pocket extending along the first plurality of inflatable chambers. The second sleeve may comprise a second plurality of inflatable chambers and a second pocket extending along the second plurality of inflatable chambers. The air conduit network may extend to the first plurality of inflatable chambers through the first pocket and to the second plurality of inflatable chambers through the second pocket.

Some aspects of the present disclosure relate to a compression therapy device. The compression therapy device may comprise a first sleeve configured to receive a first limb of a wearer. The compression therapy device may comprise a second sleeve configured to receive a second limb of the wearer. The compression therapy device may comprise a first chamber pair. The first chamber pair may include a first inflatable chamber in the first sleeve and a first inflatable chamber in the second sleeve. The first inflatable chamber of the first sleeve may be in fluid communication with the first inflatable chamber of the second sleeve. The compression therapy device may comprise a second chamber pair. The second chamber pair may include a second inflatable chamber in the first sleeve and a second inflatable chamber in the second sleeve. The second inflatable chamber of the first sleeve may be in fluid communication with the second inflatable chamber of the second sleeve. The first chamber pair may be selectively fluidly isolatable from the second chamber pair.

In some embodiments according to any of the foregoing, the compression therapy device may comprise a controller, a pump, and a pump interface. The controller may be configured to control the pump and pump interface to inflate the second chamber pair while an internal pressure of the first chamber pair remains constant.

In some embodiments according to any of the foregoing, the compression therapy device may comprise a control panel mounted to the first sleeve. The controller may be configured to receive user inputs through the control panel and communicate control signals through wired connections to the first sleeve and second sleeve.

In some embodiments according to any of the foregoing, the pump and pump interface may be mounted to the first sleeve.

In some embodiments according to any of the foregoing, the compression therapy device may be configured to prevent an internal pressure of the second chamber pair from rising to a same magnitude as an internal pressure of the first chamber pair.

In some embodiments according to any of the foregoing, the compression therapy device may comprise a third chamber pair including an inflatable chamber in each of the first sleeve and the second sleeve. The compression therapy device may comprise a fourth chamber pair including an inflatable chamber in each of the first sleeve and the second sleeve. The compression therapy device may be configured to prevent an internal pressure of the third chamber pair from rising to a same magnitude as the internal pressure of the second chamber pair and to prevent an internal pressure of the fourth chamber pair from rising to a same magnitude as the internal pressure of the third chamber pair.

In some embodiments according to any of the foregoing, the first inflatable chamber may be configured to receive and compress a first portion of the first limb, the third inflatable chamber is configured to receive and compress a second portion of the first limb, and first portion is distal of the second portion.

In some embodiments according to any of the foregoing, the first sleeve and the second sleeve may each comprise a proximal end and a distal end, and the compression therapy device comprises a bridge joining the proximal ends.

Further features and advantages, as well as the structure and operation of various embodiments, are described in detail below with reference to the accompanying drawings. It is noted that the specific embodiments described herein are not intended to be limiting. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the pertinent art to make and use the disclosure.

FIG. 1 is a front elevation view of a compression therapy device according to some aspects of the present disclosure.

FIG. 2 is a diagrammatic representation of certain features of a compression sleeve according to some aspects of the present disclosure in cross section.

FIG. 3 illustrates an inflation sequence of the compression sleeve of FIG. 2.

FIG. 4 is a front elevation view of the compression therapy device of FIG. 1.

FIG. 5 is an oblique perspective view of an aspect of the compressive therapy device of FIG. 1.

FIG. 6 is a front elevation view of a pump interface of the compression therapy device of FIG. 1.

FIG. 7 is an inverted front elevation view of a control panel of the compression therapy device of FIG. 1.

Embodiments of the present disclosure will be described with reference to the accompanying drawings.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment might not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc. Further, any of the implementation variations may be carried out by a general purpose computer, as described below.

For purposes of this disclosure, the term “module” may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

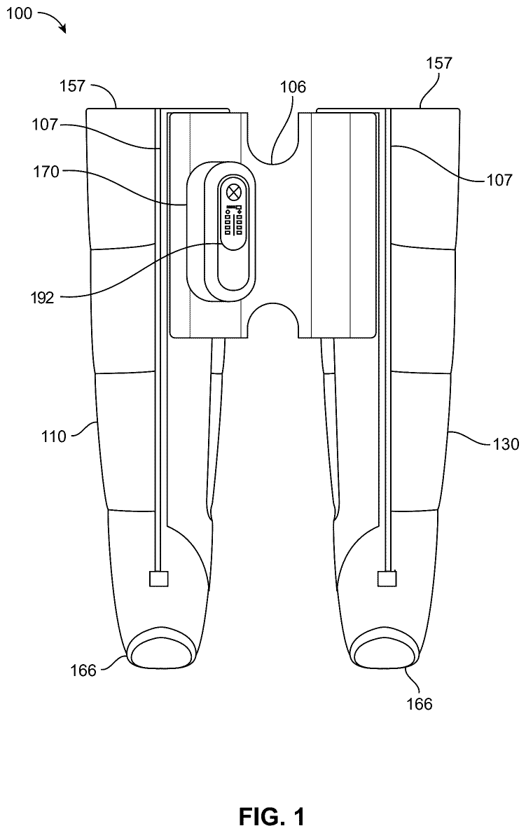

FIG. 1 illustrates a compression therapy device 100. Compression therapy device 100 comprises a first sleeve 110 and a second sleeve 130. First sleeve 110 is configured to receive a first limb of a user. Second sleeve 130 is configured to receive a second limb of the user. First sleeve 110 and second sleeve 130 are each configured to pneumatically compress the respective received limb. First sleeve 110 and second sleeve 130 of the illustrated example are each configured to receive and compress a leg and foot of a wearer, and thus gives compression therapy device 100 the overall form of a pair of boots. Thus, in the illustrated example, the first limb is a first leg and the second limb is a second leg. However, in other examples, first sleeve 110 and second sleeve 130 can be configured otherwise, such as for each receiving and compressing an arm of a wearer.

Further, in the illustrated example first sleeve 110 is a right sleeve configured to receive a right leg of a wearer and second sleeve 130 is a left sleeve configured to receive a left leg of a wearer. However, in other examples, the left and right arrangement of first sleeve 110 and second sleeve 130 can be reversed. Moreover, any features described with respect to first sleeve 110 or second sleeve 130 can be freely moved to the other sleeve in other examples unless stated otherwise.

Compression therapy device 100 comprises a bridge 106 that joins first sleeve 110 to second sleeve 130. First sleeve 110 and second sleeve 130 each comprise a proximal end 157 and a distal end 166. Bridge 106 of the illustrated example is positioned nearer to proximal ends 157 of first sleeve 110 and second sleeve 130. In particular, in the illustrated example, bridge 106 bridge joins proximal ends 157 of first sleeve 110 and second sleeve 130. Further, distal ends 166 of first sleeve 110 and second sleeve 130 are not connected, leaving distal ends 166 free to move independently from one another. This configuration connects sleeves 110, 130 to one another while providing a user with some mobility, such as freedom to move either or both feet independently while using compression therapy device 100, which can contribute to the comfort and convenience associated with using compression therapy device 100. However, bridge 106 can be located elsewhere in other examples.

Bridge 106 can be made of a flexible material. For example, bridge 106 can be made of fabric or of one or more sheets of flexible polymer. A flexible bridge 106 can also contribute to mobility and comfort for a wearer of compression therapy device 100 by allowing the wearer some freedom to move a limb received in first sleeve 110 relative to a limb received in second sleeve 130. A flexible bridge 106 can also allow first sleeve 110 and second sleeve 130 to be folded together when compression therapy device 100 is not in use to enable storage of compression therapy device 100 in relatively small spaces. However, bridge 106 need not be flexible in all cases, and can be constructed of inflexible materials in other examples.

Each sleeve 110, 130 of the illustrated example includes a seams 107 that can be opened to facilitate donning and removing compression therapy device 100. Seams 107 can be selectively fastenable, such as with a zipper or other selective closure elements. In other embodiments, seams 107 can be positioned otherwise, or other features can be provided instead of seams 107 to facilitate donning and removing compression therapy device 100.

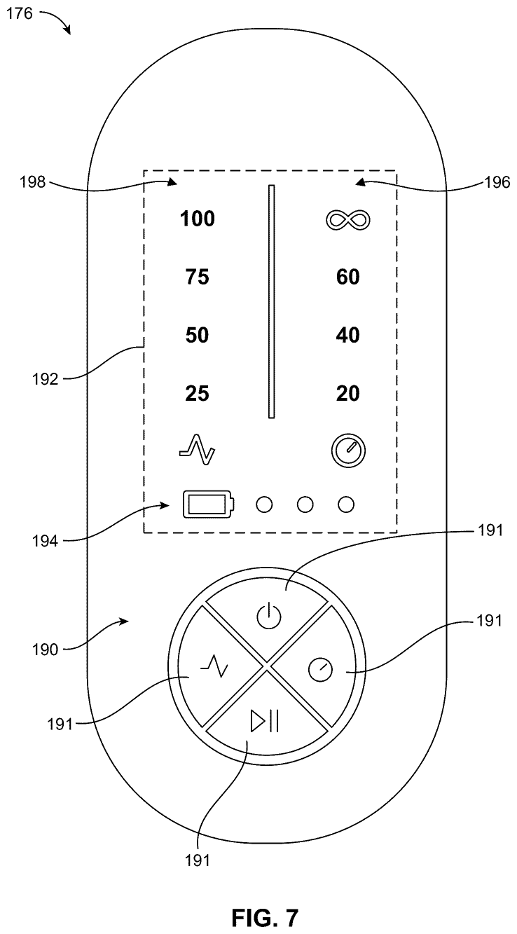

Compression therapy device 100 also comprises a control assembly 170. Control assembly 170 comprises a control panel 176, described further below with respect to FIG. 7, that acts as a user interface for controlling compression therapy device 100. Thus, the control panel 176 is also mounted to first sleeve 110. In the illustrated example, control assembly 170 is mounted to first sleeve 110 nearer to proximal end 157 of first sleeve 110 than to distal end 166 of first sleeve 110. Control assembly 170 thus provides an easily accessible way for a user to control compression therapy device 100 while wearing compression therapy device 100. However, control assembly 170 may be located elsewhere in other examples. As noted above, control assembly 170 can be relocated to second sleeve 130 in other examples.

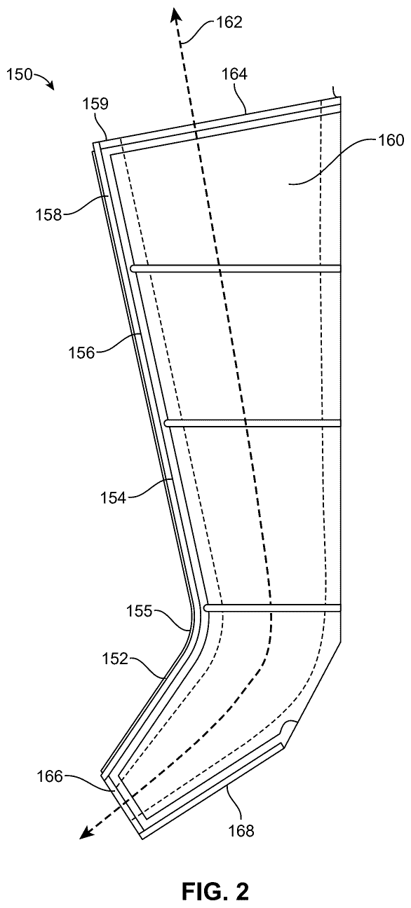

FIG. 2 diagrammatically represents certain features of a sleeve 150 in cross section. Sleeve 150 comprises structural features shared by both first sleeve 110 and second sleeve 130. Thus, details described herein with respect to sleeve 150 can be equally true of first sleeve 110 and second sleeve 130.

Sleeve 150 comprises an inflatable body 159. Inflatable body 159 defines an interior 160 configured to receive a limb of a wearer. Inflatable body 159 is configured to constrict interior 160 when inflated.

A longitudinal line 162 is defined with respect to interior 160. Longitudinal line 162 extends along a center of area of interior 160 from proximal end 164 of sleeve 150 to distal end 166 of sleeve 150. Longitudinal line 162 is therefore also a proximal-distal line of sleeve 150.

Proximal end 164 and distal end 166 are defined with respect to proximal and distal ends of the limb that sleeve 150 is configured to receive and an intended position of receipt for the limb. Thus, in the illustrated example wherein sleeve 150 is configured to receive a leg of a wearer, distal end 166 of sleeve 150 is defined at an end of sleeve 150 nearest to the portion of interior 160 configured to receive a wearer's toes when sleeve 150 is worn. Distal end 166 can therefore be distinct from a bottom surface 168 of a foot portion of sleeve 150. Similarly, proximal end 164 of sleeve 150 is an end from which a wearer's thigh extends when sleeve 150 is worn.

Because sleeve 150 of the illustrated example curves at an ankle portion 155 to accommodate an angle of a natural resting position of a foot relative to a calf, longitudinal line 162 of the illustrated example is not entirely straight. A longitudinal, proximal, or distal direction relative to any portion of sleeve 150 is accordingly defined tangent to a nearest point along longitudinal line 162. The shape of sleeve 150 can vary for other embodiments configured to receive other portions of a wearer or to accommodate design considerations. Thus, longitudinal line 162 in other embodiments may be entirely straight, may bend at more than one location, or may branch.

Inflatable body 159 comprises a series of inflatable chambers arranged along longitudinal line 162. Inflatable body 159 of the illustrated example comprises exactly four such inflatable chambers, including a first inflatable chamber 152, a second inflatable chamber 154, a third inflatable chamber 156, and a fourth inflatable chamber 158 in order from distal-most to proximal-most. Each inflatable chamber extends around a respective portion of interior 160 and can therefore constrict the portion of interior 160 when inflated. In the illustrated example, first inflatable chamber 152 is configured to receive and compress a wearer's foot, while second inflatable chamber 154, third inflatable chamber 156, and fourth inflatable chamber 158 are each configured to receive and compress a respective portion of a wearer's leg. Inflatable chambers can be apportioned differently in other examples.

At least an interior 160 facing side of each of the inflatable chambers 152, 154, 156, 158 is constructed of flexible material so that the inflatable chambers will expand into interior 160 when inflated. Inflatable body 159 can thereby constrict interior 160 as inflatable chambers 152, 154, 156, 158 are inflated.

Inflatable bodies 159 according to other examples can comprise different numbers of inflatable chambers. Moreover, instead of individual inflatable chambers that extend around a respective portion of interior 160, inflatable bodies 159 according to other examples can comprise multiple inflatable chambers at certain longitudinal positions along interior 160, said multiple inflatable chambers each being located at a different circumferential position about interior 160 to collectively surround interior 160.

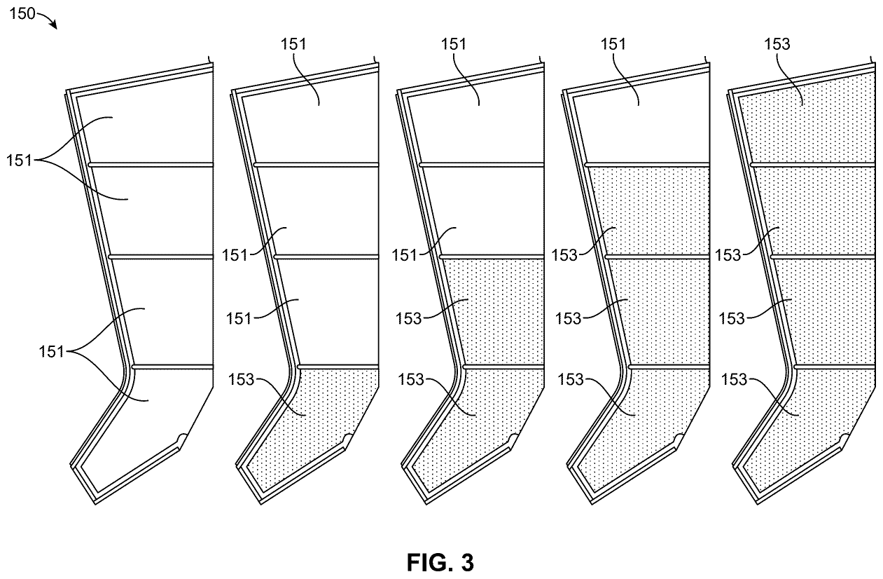

Sleeve 150 can be operated through an inflation cycle comprising an inflation sequence shown in FIG. 3. Compression therapy device 100 can be configured to execute an inflation cycle by alternating the inflation sequence shown in FIG. 3 and a deflation sequence. At an initial state before the inflation sequence, all inflatable chambers of sleeve 150 can be deflated chambers 151. The inflation sequence can then begin by first inflating a distal-most inflatable chamber, thereby converting the distal-most inflatable chamber from a deflated chamber 151 to an inflated chamber 153. The inflation sequence can then progress by sequentially inflating each deflated chamber 151 to an inflated chamber 153 in order from distal-most to proximal-most until all inflatable chambers of sleeve 150 are inflated chambers 153.

Following the inflation sequence of FIG. 3, sleeve 150 can be deflated in a deflation sequence. In some embodiments, the deflation sequence comprises deflating all inflated chambers 153 to deflated chambers 151 simultaneously. In other embodiments, the deflation sequence comprises deflating inflated chambers 153 to deflated chambers 151 in an order opposite to the order of inflating deflated chambers 151 to inflated chambers 153 in the inflation sequence. Thus, in some embodiments, a deflation sequence can comprise deflating the inflatable chambers of sleeve 150 in a proximal to distal order. Regardless of the type of deflation sequence, an inflation cycle can comprise alternating inflation sequences and deflation sequences.

Compression therapy device 100 can be configured to pause for a predetermined amount of time between completing the deflation sequence and beginning the next inflation sequence. In some embodiments, the pause can be considered a gap between inflation cycles. In other embodiments, the pause can be considered a final portion of the inflation cycle. In some embodiments, the predetermined amount of time for the pause can be a fixed amount of time that cannot be altered by a user. In other embodiments, the predetermined amount of time for the pause can be configurable by a user. In some embodiments, the predetermined amount of time can be in a range from 10 seconds to 60 seconds. In some further embodiments, the predetermined amount of time can be 15 seconds.

By inflating the inflatable chambers in order from distal to proximal, then deflating the inflatable chambers, the inflation cycle can apply compression to the compressed limb in a manner that drives blood from the wearer's extremities to the wearer's core, which is associated with a number of therapeutic benefits. Additionally, the cyclical application and removal of compression to the limb in sleeve 150 can massage the limb's muscles and provide additional therapeutic benefits.

In some embodiments, sleeve 150 can be configured to enforce the order of inflation shown in the inflation sequence of FIG. 3 by preventing a pressure in any inflatable chamber from exceeding a pressure in the next, more distal inflatable chamber. Thus, referring to the numbering of chambers described above with respect to FIG. 2, sleeve 150 can be configured to prevent an internal pressure of second inflatable chamber 154 from exceeding an internal pressure of first inflatable chamber 152. Similarly, sleeve 150 can further be configured to prevent an internal pressure of third inflatable chamber 156 from exceeding the internal pressure of second inflatable chamber 154 and to prevent an internal pressure of fourth inflatable chamber 158 from exceeding the internal pressure of third inflatable chamber 156. This configuration can prevent sleeve 150 from reaching a state where compression force on a received limb at a proximal location exceeds compression force on the received limb at a distal location, which could drive blood away from the wearer's core.

In some further embodiments, sleeve 150 can further be configured to prevent a pressure within any inflatable chamber from rising to the same magnitude as a pressure of a next, more distal inflatable chamber during the inflation cycle. Thus, in some embodiments, sleeve 150 can be configured to prevent an internal pressure of second inflatable chamber 154 from rising to the same magnitude as an internal pressure of first inflatable chamber 152. Similarly, sleeve 150 can further be configured to prevent an internal pressure of third inflatable chamber 156 from rising to the same magnitude as the internal pressure of second inflatable chamber 154 and to prevent an internal pressure of fourth inflatable chamber 158 from rising to the same magnitude as the internal pressure of third inflatable chamber 156. Thus, sleeve 150 may be configured such that the internal pressure of any inflatable chamber of sleeve 150 must be greater than the internal pressure of any more proximal inflatable chambers of sleeve 150 during the inflation cycle. This configuration can force sleeve 150 to a decreasing distal to proximal pressure gradient whenever sleeve 150 is inflated, thereby ensuring that sleeve 150 acts to drive a wearer's blood toward the wearer's core.

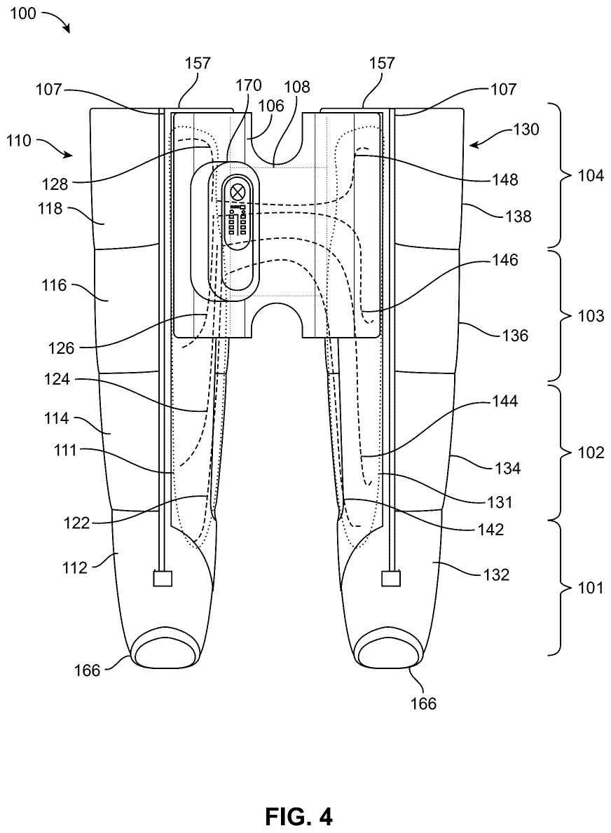

Turning to FIG. 4, with continued reference to FIGS. 2 and 3, first sleeve 110 and second sleeve 130 each comprise the features described above with respect to sleeve 150. Thus, like sleeve 150, first sleeve 110 and second sleeve 130 each comprise a respective inflatable body defining an interior configured to receive a limb of a wearer. Like the inflatable body 159 of sleeve 150, the inflatable bodies of first sleeve 110 and second sleeve 130 each comprise a respective series of inflatable chambers arranged along a longitudinal line of the sleeve defined with respect to the interior. In particular, first sleeve 110 comprises a first inflatable chamber 112, a second inflatable chamber 114, a third inflatable chamber 116, and a fourth inflatable chamber 118 in order from distal-most to proximal-most. Second sleeve 130 likewise comprises a first inflatable chamber 132, a second inflatable chamber 134, a third inflatable chamber 136, and a fourth inflatable chamber 138 in order from distal-most to proximal-most.

Each inflatable chamber of first sleeve 110 is configured to compress a respective portion of a first limb of a wearer when inflated and each inflatable chamber of second sleeve 130 is configured to compress a respective portion of a second limb of a wearer when inflated. The portion of the first limb compressed by each inflatable chamber of first sleeve 110 can correspond to the portion of the second limb compressed by the corresponding inflatable chamber of second sleeve 130. Thus, compression therapy device 100 may comprise pairs of inflatable chambers, wherein each pair of inflatable chambers comprises an inflatable chamber of first sleeve 110 and an inflatable chamber of second sleeve 130. Each pair of inflatable chambers may be configured to compress the same portion of both limbs that compression therapy device 100 is configured to treat.

Compression therapy device 100 of the illustrated example comprises a first chamber pair 101, second chamber pair, 102, third chamber pair 103, and fourth chamber pair 104. First chamber pair 101 comprises first inflatable chamber 112 of first sleeve 110 and first inflatable chamber 132 of second sleeve 130. Second chamber pair 102 comprises second inflatable chamber 114 of first sleeve 110 and second inflatable chamber 134 of second sleeve 130. Third chamber pair 103 comprises third inflatable chamber 116 of first sleeve 110 and third inflatable chamber 136 of second sleeve 130. Fourth chamber pair 104 comprises fourth inflatable chamber 118 of first sleeve 110 and fourth inflatable chamber 138 of second sleeve 130. In various embodiments of compression therapy device 100, the number of pairs of inflatable chambers may vary along with the number of inflatable chambers in each sleeve 110, 130.

First sleeve 110 and second sleeve 130 are configured to execute the same inflation cycle described above with respect to sleeve 150 and FIG. 3. In some embodiments, first sleeve 110 and second sleeve 130 can each be configured to prevent internal pressure of any inflatable chamber within either sleeve from exceeding an internal pressure of a next, more distal inflatable chamber within the same sleeve as described above with respect to sleeve 150. In some further embodiments, first sleeve 110 and second sleeve 130 can each further be configured to prevent internal pressure of any inflatable chamber within either sleeve from rising to the same magnitude of an internal pressure of a next, more distal inflatable chamber within the same sleeve during an inflation cycle as also described above with respect to sleeve 150.

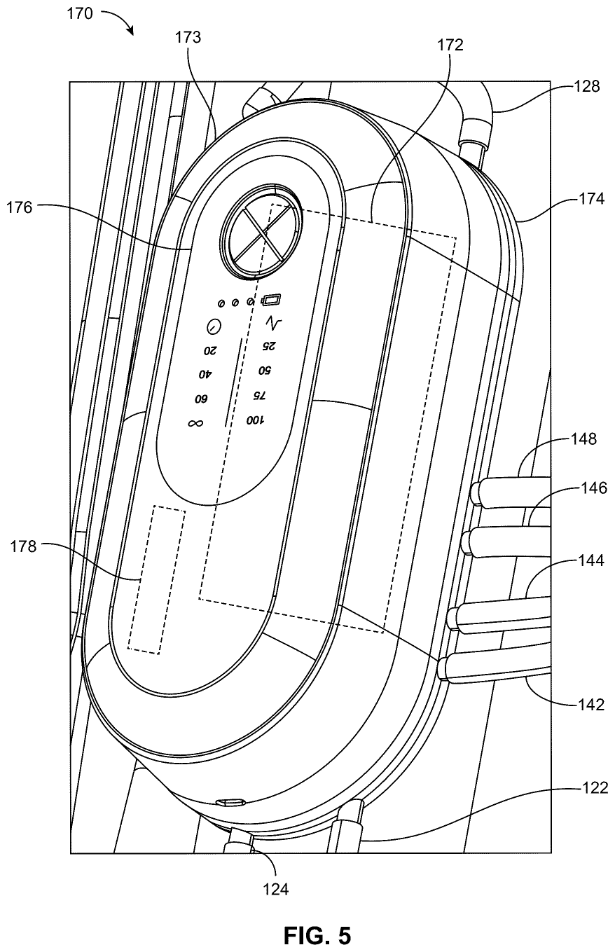

As shown in FIG. 4, control assembly 170 of the illustrated example comprises a pump (described further below with respect to FIG. 5 as pump 172), and compression therapy device 100 comprises an air conduit network configured to distribute air from the pump. The air conduit network extends from first sleeve 110 to second sleeve 130. The pump is configured to inflate first sleeve 110 and second sleeve 130 through the air conduit network.

The air conduit network of compression therapy device 100 comprises a respective set of air conduits for each sleeve 110, 130. Thus, compression therapy device 100 comprises a first set of air conduits and a second set of air conduits. The conduits in each set provide fluid communication between the pump and the inflatable chambers of the respective sleeve 110, 130. A first set of air conduits within the air conduit network comprises a first air conduit 122 extending to first inflatable chamber 112 of first sleeve 110, a second air conduit 124 extending to second inflatable chamber 114 of first sleeve 110, a third air conduit 126 extending to third inflatable chamber 116 of first sleeve 110, and a fourth air conduit 128 extending to fourth inflatable chamber 118 of first sleeve 110. Likewise, a second set of air conduits within the air conduit network comprises a first air conduit 142 extending to first inflatable chamber 132 of second sleeve 130, a second air conduit 144 extending to second inflatable chamber 134 of second sleeve 130, a third air conduit 146 extending to third inflatable chamber 136 of second sleeve 130, and a fourth air conduit 148 extending to fourth inflatable chamber 138 of second sleeve 130.

In some embodiments, the air conduits can be configured to prevent disconnection of the air conduits from control assembly 170 or inflatable chambers during ordinary use. For example, because the air conduits are routed through pockets 111, 131, the connection points of the air conduits to the inflatable chambers and control assembly 170 may be covered by the outer layers of pockets 111, 131, which may inhibit access to those connection points and thereby prevent disconnection of the air conduits.

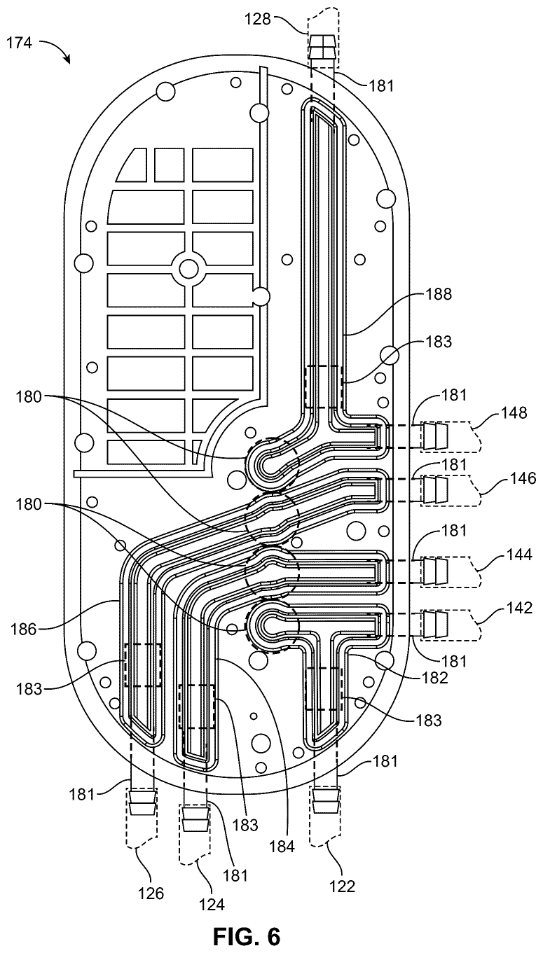

Thus, compression therapy device 100 comprises a first air conduit 122 within the first set of air conduits that extends from a pump interface 174, described further below with respect to FIGS. 5 and 6, to first inflatable chamber 112 of first sleeve 110. Similarly, compression therapy device 100 comprises a first air conduit 142 within the second set of air conduits that extends from pump interface 174 to first inflatable chamber 132 of second sleeve 110.

Moreover, the air conduit network comprises a second air conduit 124, a third air conduit 126, and a fourth air conduit 128 within the first set of air conduits. The second air conduit 124, third air conduit 126, and fourth air conduit 128 of the first set of air conduits each extend to a respective inflatable chamber 114, 116, 118 of first sleeve 110.

Further, the air conduit network comprises a second air conduit 144, a third air conduit 146, and a fourth air conduit 148 within the second set of air conduits. The second air conduit 144, third air conduit 146, and fourth air conduit 148 within the second set of air conduits each extend to a respective inflatable chamber 134, 136, 138 of second sleeve 130.

In further embodiments, the number of inflatable chambers in each sleeve may vary, and the number of air conduits in the air conduit network may vary proportionally such that each inflatable chamber has a corresponding air conduit for carrying air to or from the pump.

Because control assembly 170 comprises a pump and control assembly 170 is mounted to first sleeve 110, the pump is also mounted to first sleeve. Bridge 106 comprises a passage 108. The air conduit network extends through the passage 108 defined in bridge 106 into second sleeve 130. Moreover, the air conduit network extends through passage 108 from the pump to inflatable chambers 132, 134, 136, 138 of second sleeve 130. Thus, in addition to structurally connecting first sleeve 110 to second sleeve 130, bridge 106 also provides an enclosure in the form of passage 108 for the purpose of enclosing the portion of the air conduit network that extends between first sleeve 110 and second sleeve 130.

First sleeve 110 of the illustrated example comprises a first pocket 111 extending along the inflatable chambers 112, 114, 116, 118 of first sleeve. Likewise, second sleeve 130 of the illustrated embodiment also comprises a second pocket 131 extending along the inflatable chambers 132, 134, 136, 138. Thus, first sleeve 110 comprises a first plurality of inflatable chambers and a first pocket 111 extending along the first plurality of inflatable chambers. Similarly, second sleeve 130 comprises a second plurality of inflatable chambers and a second pocket 131 extending along the second plurality of inflatable chambers.

The portion of the air conduit network extending from the pump to the inflatable chambers 112, 114, 116, 118 is routed through first pocket 111. Thus, first air conduit 122, second air conduit 124, third air conduit 126, and fourth air conduit 128 can extend through first pocket 111. Similarly, the portion of the air conduit network extending from the pump to the inflatable chambers 132, 134, 136, 138 can be routed through passage 108 and then second pocket 131. Thus, first air conduit 142, second air conduit 144, third air conduit 146, and fourth air conduit 148 can extend through second pocket 131.

Accordingly, the air conduit network extends to the first plurality of inflatable chambers through first pocket 111 and to the second plurality of inflatable chambers through second pocket 131. Routing the air conduits through pockets 111, 131 in this manner can contribute to a sleek appearance for compression therapy device 100 and reduce the likelihood that the air conduit network will become damaged during use, transport, and storage.

In the illustrated example, each inflatable chamber in first sleeve 110 is paired with an inflatable chamber in second sleeve 130. Compression therapy device 100 can be configured to apply equal inflation pressure to both inflatable chambers in any inflatable chamber pair. For example, first inflatable chamber 112 of first sleeve 110 is paired to first inflatable chamber 132 of second sleeve 130. Compression therapy device 100 can be configured to apply equal inflation pressure to first inflatable chamber 112 of first sleeve 110 and first inflatable chamber 132 of second sleeve 130 during any inflation or deflation sequence. In the illustrated example, second inflatable chamber 114 of first sleeve 110 can be paired in the same manner to second inflatable chamber 134 of second sleeve 130, third inflatable chamber 116 of first sleeve 110 can be paired in the same manner to third inflatable chamber 136 of second sleeve 130, and fourth inflatable chamber 118 of first sleeve 110 can be paired in the same manner to fourth inflatable chamber 138 of second sleeve 130.

In some embodiments, the equal inflation pressure applied to both inflatable chambers in a pair can be applied by establishing fluid communication between the two inflatable chambers in the pair through the air conduit network. For example, in some embodiments, the air conduit network can be configured to establish fluid communication between first inflatable chamber 112 of first sleeve 110 and first inflatable chamber 132 of second sleeve 130. In some embodiments, the air conduit network can be similarly configured to establish fluid communication between both second inflatable chambers 114, 134, between both third chambers 116, 136, and between both fourth chambers 118, 138. Equalizing pressure between pairs of inflatable chambers in first sleeve 110 and second sleeve 130 by establishing fluid communication between the two inflatable chambers can be a relatively simple and cost-effective way to ensure that compression therapy device 100 provides synchronized, symmetrical treatment to both limbs received in first sleeve 110 and second sleeve 130. For example, the air conduit network extending into both sleeves 110, 130 can enable both sleeves 110, 130 to be inflated in a synchronized manner without the need for any wireless communication hardware. Thus, in some embodiments, compression therapy device 100 lacks any wireless communication devices.

The inflatable chambers of sleeves 110, 130 can be inflated in the same manner and can be subject to the same constraints as described above with respect to the inflatable chambers of sleeve 150. Thus, the features described above with respect to the inflation of inflatable chambers of sleeve 150 can also be true with respect to the inflation of the chamber pairs of sleeves 110, 130.

For example, compression therapy device 100 can be configured to prevent an internal pressure of any inflatable chamber pair from exceeding an internal pressure of a next, more distal chamber pair. Thus, in some embodiments, compression therapy device 100 can be configured to prevent an internal pressure of a second chamber pair 102 comprising second inflatable chambers 114, 134 from exceeding an internal pressure of a first chamber pair 101 comprising first inflatable chambers 112, 132. In further embodiments, compression therapy device 100 can be configured to prevent an internal pressure of a third chamber pair 103 comprising third inflatable chambers 116, 136 from exceeding the internal pressure of the second chamber pair 102. In further embodiments, compression therapy device 100 can be configured to prevent an internal pressure of a fourth chamber pair 104 comprising fourth inflatable chambers 118, 138 from exceeding the internal pressure of the third chamber pair 103.

In another example, compression therapy device 100 can be configured to prevent an internal pressure of any inflatable chamber pair from rising to a same magnitude as an internal pressure of a next, more distal chamber pair. Thus, in some embodiments, compression therapy device 100 can be configured to prevent an internal pressure of a second chamber pair 102 comprising second inflatable chambers 114,134 from rising to a same magnitude as an internal pressure of a first chamber pair 101 comprising first inflatable chambers 112, 132. In further embodiments, compression therapy device 100 can be configured to prevent an internal pressure of a third chamber pair 103 comprising third inflatable chambers 116, 136 from rising to a same magnitude as the internal pressure of the second chamber pair 102. In further embodiments, compression therapy device 100 can be configured to prevent an internal pressure of a fourth chamber pair 104 comprising fourth inflatable chambers 118, 138 from rising to a same magnitude as the internal pressure of the third chamber pair 103.

In some embodiments, compression therapy device 100 can accomplish the above described boundaries on internal pressures within chambers pairs 101, 102, 103, 104 by use of a controller 178 controlling valves 180 in response to measurements acquired by pressure sensors 183, as shown in FIG. 6. Thus, in some embodiments, compression therapy device 100 may be configured to prevent an internal pressure of any inflatable chamber pair from exceeding an internal pressure of a next, more distal chamber pair by using a controller 178, wherein the controller 178 is configured to close a valve 180 controlling air flow to one chamber pair when pressure sensors 183 indicate that internal pressure within the one chamber pair equals the internal pressure within the next, more distal chamber pair. In some further embodiments, compression therapy device 100 may be configured to prevent an internal pressure of any inflatable chamber pair from rising to a chamber magnitude as an internal pressure of a next, more distal chamber pair by using a controller 178, wherein the controller 178 is configured to close a valve 180 controlling air flow to one chamber pair when pressure sensors 183 indicate that internal pressure within the one chamber pair is less than a predetermined amount below internal pressure within the next, more distal chamber pair.

FIG. 5 illustrates control assembly 170. Control assembly 170 of the illustrated examples comprises pump 172, control panel 176, controller 178, pump case 173, and pump interface 174. Pump 172 and pump interface 174 are therefore mounted to first sleeve 110 in the illustrated example. Integrating pump 172, control panel 176, and controller 178 in a single assembly as shown in the illustrated example can contribute to giving compression therapy device 100 a sleek appearance and facilitate folding compression therapy device 100 into a smaller space by minimizing the number of distinct solid elements distributed around compression therapy device 100.

In some embodiments, controller 178 can be in electronic communication with elements in both first sleeve 110 and second sleeve 130. For examples, controller 178 can be configured to receive measurements from pressure sensors associated with the inflatable chambers of both sleeves 110, 130 or to actuate valves controlling airflow into or out of the inflatable chambers of both sleeves 110, 130. In some such embodiments, controller 178 can be configured to communicate control signals through wired connections to first sleeve 110 and second sleeve 130. In some embodiments, the pressure sensors may be located in the pump interface 174 and configured to electronically communicate with controller 178 regarding pressure measurements of each inflatable chamber of both sleeves 110, 130.

However, in other embodiments, certain elements described herein as being part of control assembly 170 can be separated from one another and distributed to different locations across compression therapy device 100. For example, in some embodiments, control panel 176 and controller 178 can be located apart from pump 172, pump case 173, and pump interface 174. In such embodiments, controller 178 can be placed in wired or wireless electronic communication. In some such embodiments, controller 178 and control panel 176 can be mounted to first sleeve 110 while pump 172, pump case 173, and pump interface 174 can be mounted to second sleeve 130. Wires for electronic communication between controller 178 and pump 172 can be routed through passage 108, pockets 111, or both.

Pump interface 174 can connect the air conduit network to pump 172. As shown in FIG. 6, pump interface 174 can comprise connectors 181 for connecting air conduits to pump interface 174. Pump interface 174 can further comprise a plurality of air channels for carrying air from pump 172 to connectors 181. Pump interface 174 can further comprise one or more valves 180 for selectively opening or closing fluid connection between pump 172 and the air channels. In some embodiments, the pump interface 174 may include one or more pressure sensors 183 associated with the inflatable chambers of first sleeve 110 and second sleeve 130 and configured to measure pressure in each inflatable chamber. In some embodiments, the one or more pressure sensors 183 may be located in one or more valves 180, connectors 181, air channels, and/or air conduits. For example, pump interface 174 may include a pressure sensor 183 for each channel 182, 184, 186, 188. Pressure sensors 183 may be in electronic communication with controller 178. Because each channel 182, 184, 186, 188 is in fluid communication with a respective one of the chamber pairs 101, 102, 103, 104, compression therapy device 100 can use the pressure sensors 183 for each channel to measure the pressure within the inflatable chambers of both sleeves 110, 130.

Pump interface 174 of the illustrated example comprises one air channel for each of the above described pairs of inflatable chambers of first sleeve 110 and second sleeve 130. Moreover, each air channel terminates at two connectors 181 that connect to a pair of air conduits. Thus, pump interface 174 comprises a first channel 182, a second channel 184, a third channel 186, and a fourth channel 188. First channel 182 extends from a valve 180 to terminate at a connector 181 connected to first air conduit 122 for first sleeve 110 and at a connector 181 connected to first air conduit 142 for second sleeve 130.

Second channel 184 extends from a valve 180 to terminate at a connector 181 connected to second air conduit 124 for first sleeve 110 and at a connector 181 connected to second air conduit 144 for second sleeve 130. Third channel 186 extends from a valve 180 to terminate at a connector 181 connected to third air conduit 126 for first sleeve 110 and at a connector 181 connected to third air conduit 146 for second sleeve 130. Fourth channel 188 extends from a valve 180 to terminate at a connector 181 connected to fourth air conduit 128 for first sleeve 110 and at a connector 181 connected to fourth air conduit 148 for second sleeve 130.

In some embodiments, the connectors 181 may be configured for permanent connection to the ends of the respective air conduits. For example, in some embodiments, the air conduits can be permanently joined to connectors 181 by an adhesive or sealant. In further embodiments, the air conduits can be permanently joined to connectors 181 such that it is difficult or impossible to remove a connected air conduit from its connector 181 without destroying a portion of the air conduit or connector 181.

Thus, fluid communication between each pair of air conduits, and by extension each pair of two inflatable compartments split across the two sleeves 110, 130, can be established through the air channels defined in pump interface 174. An end of first air conduit 122 of the first set of air conduits can be in fluid communication with an end of first air conduit 142 of the second set of air conduits through pump interface 174. An end of second air conduit 124 of the first set of air conduits can be in fluid communication with an end of second air conduit 144 of the second set of air conduits through pump interface 174. An end of third air conduit 126 of the first set of air conduits can be in fluid communication with an end of third air conduit 146 of the second set of air conduits through pump interface 174. An end of fourth air conduit 128 of the first set of air conduits can be in fluid communication with an end of fourth air conduit 148 of the second set of air conduits through pump interface 174.

In the illustrated example, pump interface 174 comprises a separate valve 180 for each air channel. Controller 178 can be configured to open and close each valve 180 independently. Thus, pump interface 174 of the illustrated example enables each air channel 182, 184, 186, 188 to be independently opened or closed to fluid communication with pump 172 by selective actuation of valves 180.

Thus, pump interface 174 of the illustrated example comprises a first valve 180 configured to control fluid communication between pump 172 and first air conduit 122 of the first set of air conduits and first air conduit 142 of the second set of air conduits simultaneously. The first valve 180 can therefore control fluid communication between pump 172 and both first air conduits 122, 142 simultaneously. Pump interface 174 of the illustrated example also comprises a second valve 180 configured to control fluid communication between pump 172 and second air conduit 124 of the first set of air conduits and second air conduit 144 of the second set of air conduits simultaneously. The second valve 180 can therefore control fluid communication between pump 172 and both second air conduits 124, 144 simultaneously. Pump interface 174 of the illustrated example also comprises a third valve 180 configured to control fluid communication between pump 172 and third air conduit 126 of the first set of air conduits and third air conduit 146 of the second set of air conduits simultaneously. The third valve 180 can therefore control fluid communication between pump 172 and both third air conduits 126, 146 simultaneously. Pump interface 174 of the illustrated example also comprises a fourth valve 180 configured to control fluid communication between pump 172 and fourth air conduit 128 of the first set of air conduits and fourth air conduit 148 of the second set of air conduits simultaneously. The fourth valve 180 can therefore control fluid communication between pump 172 and both fourth air conduits 128, 148 simultaneously. Controller 178 can be configured to operate the first, second, third, and fourth valves 180 independently. Thus, controller 178 can selectively fluidly isolate any inflatable chamber pair from any other inflatable chamber pair by actuation of the valves 180.

Because the air conduit network connects pump 172 to the inflatable chambers of first sleeve 110 and second sleeve 130, the valves 180 can further be used to control fluid communication between pump 172 and pairs of inflatable chambers simultaneously. Thus, a first valve 180 can be configured to control fluid communication between pump 172 and both first inflatable chambers 112, 132 simultaneously. A second valve 180 can be configured to control fluid communication between pump 172 and both second inflatable chambers 114, 134 simultaneously. A third valve 180 can be configured to control fluid communication between pump 172 and both third inflatable chambers 116, 136 simultaneously. A fourth valve 180 can be configured to control fluid communication between pump 172 and both fourth inflatable chambers 118, 138 simultaneously.

Through the independent operation of valves 180, compression therapy device 100 can be configured to change a pressure within one pair of inflatable chambers in first sleeve 110 and second sleeve 130 independently of a pressure within another pair of inflatable chambers in first sleeve 110 and second sleeve 130. For example, first sleeve 110 and second sleeve 130 each comprise a first inflatable chamber 112, 132 and a second inflatable chamber 114, 134, and compression therapy device 100 can be configured to change a pressure within first inflatable chambers 112, 132 independently of a pressure within second inflatable chambers 114, 134. Compression therapy device 100 can further be configured to independently change a pressure within third inflatable chambers 116, 136 and a pressure within fourth inflatable chambers 118, 138. In some embodiments, controller 178 can be configured to control pump 172 and pump interface 174 to inflate one chamber pair while an internal pressure of a next, more distal chamber pair remains constant.

FIG. 7 shows control panel 176. Control panel 176 is configured to receive user inputs for controlling the functions of compression therapy device 100. Thus, control panel 176 is configured to communicate the received user inputs to controller 178. Further, controller 178 can be configured to receive user inputs through control panel 176. For the purpose of receiving the user inputs, control panel 176 of the illustrated example comprises an input array 190 comprising buttons 191. Control panel 176 can be configured to send a different signal to controller 192 for each button 191 actuated and thereby allow a user to send a variety of inputs to controller 178 by actuating buttons 191. In some embodiments, buttons 191 can be configured to send signals for adjusting therapeutic parameters, starting or stopping a therapeutic protocol, powering compression therapy device 100 on or off, or any combination of the foregoing. In other embodiments, input array 190 can comprise other devices for receiving inputs in addition to or instead of buttons 191, such as switches, rollable elements, or touch sensitive interfaces.

Control panel 176 of the illustrated example is also configured to present information to a user of compression therapy device 100. For that purpose, control panel 176 of the illustrated example comprises a display 192. Display 192 is configured to receive signals from controller 178 and display information based on the received signals.

Display 192 is configured to display therapeutic parameters selected by a user. In the illustrated example, the displayed therapeutic parameters comprise treatment duration and treatment intensity. Thus, display 192 of the illustrated examples comprises a duration indicator 196 and an intensity indicator 198. Duration indicator 196 indicates how long compression therapy device 100 will apply compression therapy by repeating the above described inflation cycle for both sleeves 110, 130 after a user inputs a start command. Intensity indicator 198 indicates the pressure levels that the compression therapy device 100 will inflate the inflatable chambers of first sleeve 110 and second sleeve 130 to during the inflation cycle after the user inputs the start command. In embodiments wherein the inflation cycle inflates the inflatable chambers of first sleeve 110 and second sleeve 130 to create a pressure gradient across multiple of the inflatable chambers, such that different inflatable chambers in each sleeve 110, 130 may reach different maximum internal pressures during the inflation cycle, intensity indicator 198 can indicate the greatest internal pressure that will occur in any of the inflatable chambers during the inflation cycle. In other embodiments, display 192 can comprise indicators for other treatment parameters instead of or in addition to duration indicator 196 and intensity indicator 198.

Display 192 of the illustrated example further comprises a battery indicator 194. Battery indicator 194 indicates an amount of power stored in a battery of compression therapy device 100. Battery indicator 194 can also be omitted in other embodiments. In some embodiments, a battery of compression therapy device 100 is located in control assembly 170 and in electronic communication with controller 178.

Display 192 of the illustrated example is configured to present one of a predetermined set of discrete states for each indicator. Thus battery indicator 194 of the illustrated example comprises a set of bullet points, wherein each bullet point corresponds to a different range of battery charge values. In some embodiments, each bullet point of the battery indicator 194 can be a light emitting diode (LED) light indicator.

Duration indicator 196 of the illustrated example comprises a set of numbers that each correspond to a number of units of time, such as minutes, that may equal the duration of the therapy compression therapy device 100 will apply after a user inputs a start command. Duration indicator 196 of the illustrated example also comprises an infinity symbol, which can be illuminated to indicate that compression therapy device 100 is set to apply therapy indefinitely after a user inputs a start command and until the user inputs a stop command, or until the compression therapy device's battery is depleted.

Intensity indicator 198 of the illustrated example comprises a set of numbers that each indicate a measure of the internal pressure to which compression therapy device 100 will inflate the inflatable chambers of first sleeve 110 and second sleeve 130 during inflation cycles after a user inputs a start command. In some embodiments, the measure of internal pressure can be either a percentage of a maximum possible internal pressure or a number of units of pressure, such as millimeters of mercury (mmHg). In some embodiments wherein compression therapy device 100 is configured to inflate different inflatable chambers to different internal pressures during the inflation cycle, the internal pressure indicated by intensity indicator 198 may be the highest internal pressure any of the inflatable chambers will reach during the inflation cycle.

In some embodiments wherein display 192 is configured to present one of a predetermined number of discrete states for each indicator, display 192 can further be configured to present the discrete states either individually or cumulatively. As an example of individual presentation, in some embodiments, display 192 can be configured to illuminate only one of the set of values in duration indicator 196, wherein the value to be illuminated corresponds to the value selected by the user. In some embodiments, intensity indicator 198 can also be configured for individual presentation.

As an example of cumulative presentation, display 192 can be configured to illuminate the bullet point of battery indicator 194 corresponding to a current value of battery charge as well as all bullet points of battery indicator 194 corresponding to lower values of battery charge. Thus, in embodiments wherein battery indicator 194 is configured for cumulative presentation, display 192 can be configured to leave unlit only bullet points within battery indicator 194 that correspond to values of battery charge exceeding a current battery charge value.

In further embodiments, any of the indicators 194, 196, 198 of display 192 can be configured for individual or cumulative presentation. Thus, for example, duration indicator 196 and intensity indicator 198 can be configured for cumulative presentation by being configured to additionally illuminate duration and pressure values below the values selected by the user. In another example, battery indicator 194 can be configured for individual presentation by being configured to only illuminate one bullet point at a time, wherein the bullet point to be illuminated corresponds to a current battery charge value.

In embodiments such as that of the illustrated example wherein display 192 is configured to have a predetermined set of presentation states, wherein the presentation states are defined by illumination of images or characters at different fixed positions across display 192, display 192 can comprise a largely opaque face with discrete transparent portions corresponding to the illuminable images or characters. In such embodiments, display 192 can further comprise an array of independent lights positioned behind the face to selectively illuminate the discrete transparent portions as appropriate for each display state. This plate and light array assembly can be a relatively cost-effective form of display 192 suitable for embodiments wherein only a limited range of information is to be displayed. However, in other embodiments, display 192 can be provided by another type of display device, such as a digital screen.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

1. A compression therapy device, comprising:
a first sleeve configured to receive a first limb of a wearer;
a second sleeve configured to receive a second limb of the wearer;
an air conduit network that extends from the first sleeve to the second sleeve;
a pump configured to inflate the first sleeve and the second sleeve through the air conduit network;
wherein the first sleeve and the second sleeve each comprise a first inflatable chamber and a second inflatable chamber, and the compression therapy device is configured to change a pressure within the first inflatable chambers independently of a pressure within the second inflatable chambers; and
wherein the compression therapy device further comprises a pump interface connecting the pump to the air conduit network, wherein the pump interface comprises a first valve and a second valve, the first valve being configured to control fluid communication between the pump and the first inflatable chambers simultaneously, and the second valve being configured to control fluid communication between the pump and the second inflatable chambers simultaneously.

2. The compression therapy device of claim 1, wherein the pump is mounted to the first sleeve.

3. The compression therapy device of claim 1, comprising a control panel mounted to the first sleeve.

4. The compression therapy device of claim 1, comprising a bridge joining the first sleeve to the second sleeve, wherein:
the bridge comprises a passage, and the air conduit network comprises:
a first air conduit that extends from the pump interface to the first inflatable chamber of the second sleeve, and
a second air conduit that extends from the pump interface to the second inflatable chamber of the second sleeve; and
wherein the first air conduit and second air conduit both pass through the passage between the pump interface and the second sleeve.

5. The compression therapy device of claim 1, wherein:
the air conduit network comprises a first set of air conduits and a second set of air conduits;
the first set of air conduits comprises a first air conduit extending from the pump interface to an inflatable chamber of the first sleeve;
the second set of air conduits comprises a first air conduit extending from the pump interface to an inflatable chamber of the second sleeve; and
the first valve is configured to control fluid communication between the pump and the both of the first air conduits simultaneously.

6. The compression therapy device of claim 5, wherein:
the first set of air conduits comprises a second air conduit, a third air conduit, and a fourth air conduit;
the second set of air conduits comprises a second air conduit, a third air conduit, and a fourth air conduit;
the second valve is configured to control fluid communication between the pump and both of the second air conduits simultaneously;
the pump interface comprises a third valve configured to control fluid communication between the pump and both of the third air conduits simultaneously;
the pump interface comprises a fourth valve configured to control fluid communication between the pump and both of the fourth air conduits simultaneously; and
the compression therapy device comprises a controller configured to operate the first, second, third, and fourth valves independently.

7. The compression therapy device of claim 6, wherein the second air conduit, the third air conduit, and the fourth air conduit of the first set of air conduits each extend to a respective inflatable chamber of the first sleeve, and wherein the second air conduit, the third air conduit, and the fourth air conduit of the second set of air conduits each extend to a respective inflatable chamber of the second sleeve.

8. The compression therapy device of claim 5, wherein an end of the first air conduit of the first set of air conduits is in fluid communication with an end of the first air conduit of the second set of air conduits through the pump interface.

9. (canceled)

10. (canceled)

11. (canceled)

12. The compression therapy device of claim 1, wherein the first sleeve comprises a first plurality of inflatable chambers and a first pocket extending along the first plurality of inflatable chambers, the second sleeve comprises a second plurality of inflatable chambers and a second pocket extending along the second plurality of inflatable chambers, and the air conduit network extends to the first plurality of inflatable chambers through the first pocket and to the second plurality of inflatable chambers through the second pocket.

13. A compression therapy device comprising:
a first sleeve configured to receive a first limb of a wearer;
a second sleeve configured to receive a second limb of the wearer;
a first chamber pair, the first chamber pair including a first inflatable chamber in the first sleeve and a first inflatable chamber in the second sleeve, wherein the first inflatable chamber of the first sleeve is in fluid communication with the first inflatable chamber of the second sleeve;
a second chamber pair, the second chamber pair including a second inflatable chamber in the first sleeve and a second inflatable chamber in the second sleeve, wherein the second inflatable chamber of the first sleeve is in fluid communication with the second inflatable chamber of the second sleeve;
a pump; and
a pump interface comprising:
a first channel, wherein the chambers of the first chamber pair are in fluid communication with one another through the first channel,
a second channel, wherein the chambers of the second chamber pair are in fluid communication with one another through the second channel, and
a first pressure sensor configured to measure air pressure in the first channel and a second pressure sensor configured to measure air pressure in the second channel;
wherein the first chamber pair is selectively fluidly isolatable from the second chamber pair.

14. The compression therapy device of claim 13, comprising a controller configured to control the pump and pump interface to inflate the second chamber pair while an internal pressure of the first chamber pair remains constant.

15. The compression therapy device of claim 14, comprising a control panel mounted to the first sleeve, wherein the controller is configured to receive user inputs through the control panel and communicate control signals through wired connections to the first sleeve and second sleeve.

16. The compression therapy device of claim 13, wherein the pump and pump interface are mounted to the first sleeve.

17. The compression therapy device of claim 14, configured to prevent an internal pressure of the second chamber pair from rising to a same magnitude as an internal pressure of the first chamber pair.

18. The compression therapy device of claim 17, comprising:
a third chamber pair including an inflatable chamber in each of the first sleeve and the second sleeve; and
a fourth chamber pair including an inflatable chamber in each of the first sleeve and the second sleeve;
wherein the compression therapy device is configured to prevent an internal pressure of the third chamber pair from rising to a same magnitude as the internal pressure of the second chamber pair and to prevent an internal pressure of the fourth chamber pair from rising to a same magnitude as the internal pressure of the third chamber pair.

19. The compression therapy device of claim 17, wherein the first inflatable chamber is configured to receive and compress a first portion of the first limb, the third inflatable chamber is configured to receive and compress a second portion of the first limb, and the first portion is distal of the second portion, and wherein the first limb is a first leg and the second limb is a second leg.

20. The compression therapy device of claim 13, wherein the first sleeve and the second sleeve each comprise a proximal end and a distal end, and the compression therapy device comprises a bridge joining the proximal ends.

21. The compression therapy device of claim 1, wherein the pump interface comprises:
a first channel, wherein the first valve is configured to selectively open and close fluid communication between the pump and the first channel, and the first inflatable chambers are in fluid communication with one another through the first channel; and
a second channel, wherein the second valve is configured to selectively open and close fluid communication between the pump and the second channel, and the second inflatable chambers are in fluid communication with one another through the second channel.

22. The compression therapy device of claim 13, wherein the first chamber pair is more distal than the second chamber pair, and the controller is configured to close a valve controlling air flow to the second chamber pair when the first pressure sensor and second pressure sensor indicate that the air pressure within the second channel is less than a predetermined amount below the air pressure within the first channel.

23. (canceled)

24. The compression therapy device of claim 4, wherein the second sleeve comprises a plurality of inflatable chambers and a pocket extending along the plurality of inflatable chambers, wherein:
the plurality of inflatable chambers comprises the first inflatable chamber of the second sleeve and the second inflatable chamber of the second sleeve,
the air conduit network extends to the plurality of inflatable chambers through the pocket,
the pump interface is mounted to the first sleeve, and
the passage of the bridge extends from the pump interface to the pocket of the second sleeve.
